(19) United States
(12) Patent Application Publication
(10) Pub. No.: US 2022/0004955 A1
(43) Pub. Date: Jan. 6, 2022

(54) METHOD AND SYSTEM FOR DETERMINING RESOURCE ALLOCATION INSTRUCTION SET FOR MEAL PREPARATION

(71) Applicant: KPN INNOVATIONS, LLC., LAKEWOOD, CO (US)

(72) Inventor: Kenneth Neumann, LAKEWOOD, CO (US)

(21) Appl. No.: 16/919,606

(22) Filed: Jul. 2, 2020

(51) Int. Cl. G06Q 10/06; G06Q 10/08; G06Q 50/12; G06N 20/00; G06F 16/28; G06F 17/18; A23L 5/00

(52) U.S. Cl. CPC G06Q 10/06316; G06Q 10/0875; G06Q 10/06315; G06Q 50/12; A23V 2002/00; G06F 16/285; G06F 17/18; A23L 5/00; G06N 20/00

(57) ABSTRACT

A system for determining a resource allocation instruction set for meal preparation, the system comprising at least a computing device, wherein the at least a computing device is configured to receive a plurality of identifications of meals. Computing device may retrieve a plurality of task chains, wherein retrieving further comprises retrieving, for each meal, a task chain identifying a plurality of sequentially ordered tasks for preparation of the meal, identifying, for each task chain, a resource list. Computing device may generate a plurality of candidate task chain combinations. Computing device may identify a plurality of constraints as a function of the plurality of identifications of meals. Computing device may select a candidate task chain combination, of the plurality of candidate task chain combinations by generating an objective function of the plurality of candidate task chain combinations.

### FIELD OF THE INVENTION

The present invention generally relates to the field of machine-learning. In particular, the present invention is directed to a method and system for determining resource allocation instruction set for meal preparation.

### BACKGROUND

Machine-learning methods are increasingly valuable for analysis of patterns and problem-solving using large quantities of data. However, where the data is large and varied enough, optimizing instructions for users from machine-learning outputs can become untenable, especially with tradeoffs between sophistication and efficiency.

### SUMMARY OF THE DISCLOSURE

In an aspect, a system for determining resource allocation instruction set for meal preparation, the system comprising at least a computing device, wherein the at least a computing device is configured to receive a plurality of identifications of meals to be prepared. Computing device may retrieve a plurality of task chains, wherein retrieving further comprises retrieving, for each meal of the plurality of meals, a task chain identifying a plurality of sequentially ordered tasks for preparation of the meal, and identifying, for each task chain, a resource list identifying a plurality of resources, wherein each resource is associated with a task of the plurality of sequentially ordered tasks. Computing device may generate a plurality of candidate task chain combinations, wherein each task chain combination includes a first task chain of the plurality of task chains and a second task chain of the plurality of task chains, and a first task of the first task chain and a second task of the second task chain are concurrently performed using a resource associated with each of the first task and the second task. Computing device may identify a plurality of constraints as a function of the identifications of meals, wherein the plurality of constraints includes at least a resource constraint and at least a timing constraint. Computing device may then select a candidate task chain combination, of the plurality of candidate task chain combinations, wherein selecting further comprises generating an objective function of the plurality of candidate task chain combinations, wherein the objective function is a mathematical function with a solution set including the plurality of candidate task chain combinations, the objective function generates an output of scoring candidate task chain combination according to at least a goal criterion, and computing device selects a candidate task chain combination for which the output of the objective function indicates a maximal satisfaction of the at least a goal criterion.

In another aspect, a method for determining resource allocation instruction set for meal preparation, the system comprising at least a computing device, wherein the at least a computing device is configured to receive a plurality of identifications of meals to be prepared. Computing device may retrieve a plurality of task chains, wherein retrieving further comprises retrieving, for each meal of the plurality of meals, a task chain identifying a plurality of sequentially ordered tasks for preparation of the meal, and identifying, for each task chain, a resource list identifying a plurality of resources, wherein each resource is associated with a task of the plurality of sequentially ordered tasks. Computing device may generate a plurality of candidate task chain combinations, wherein each task chain combination includes a first task chain of the plurality of task chains and a second task chain of the plurality of task chains, and a first task of the first task chain and a second task of the second task chain are concurrently performed using a resource associated with each of the first task and the second task. Computing device may identify a plurality of constraints as a function of the identifications of meals, wherein the plurality of constraints includes at least a resource constraint and at least a timing constraint. Computing device may then select a candidate task chain combination, of the plurality of candidate task chain combinations, wherein selecting further comprises generating an objective function of the plurality of candidate task chain combinations, wherein the objective function is a mathematical function with a solution set including the plurality of candidate task chain combinations, the objective function generates an output of scoring candidate task chain combination according to at least a goal criterion, and computing device selects a candidate task chain combination for which the output of the objective function indicates a maximal satisfaction of the at least a goal criterion.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a system for determining a resource allocation instruction set using machine-learning process;

FIG. 2 is a block diagram illustrating an exemplary embodiment of a meal database;

FIG. 3 is a block diagram of an exemplary embodiment of plurality of candidate task chains;

FIG. 4 is a block diagram of an exemplary embodiment of a machine-learning module;

FIG. 5 is a block diagram illustrating an exemplary embodiment of a method for determining a resource allocation instruction set using a machine-learning process;

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for determining resource allocation instruction set for meal preparation using a machine-learning process. In non-limiting illustrative embodiments, system may determine resource and/or task allocation by formulating and maximizing and/or minimizing an objective function. Objective function may have inputs and/or a solution set including a plurality of candidate task chain combinations, where each task chain is a sequence of tasks to be performed in preparing a meal, and each task combination includes at least two intersecting task chains. Feasibility may be determined in accordance with constraints affecting valid and/or invalid combinations.

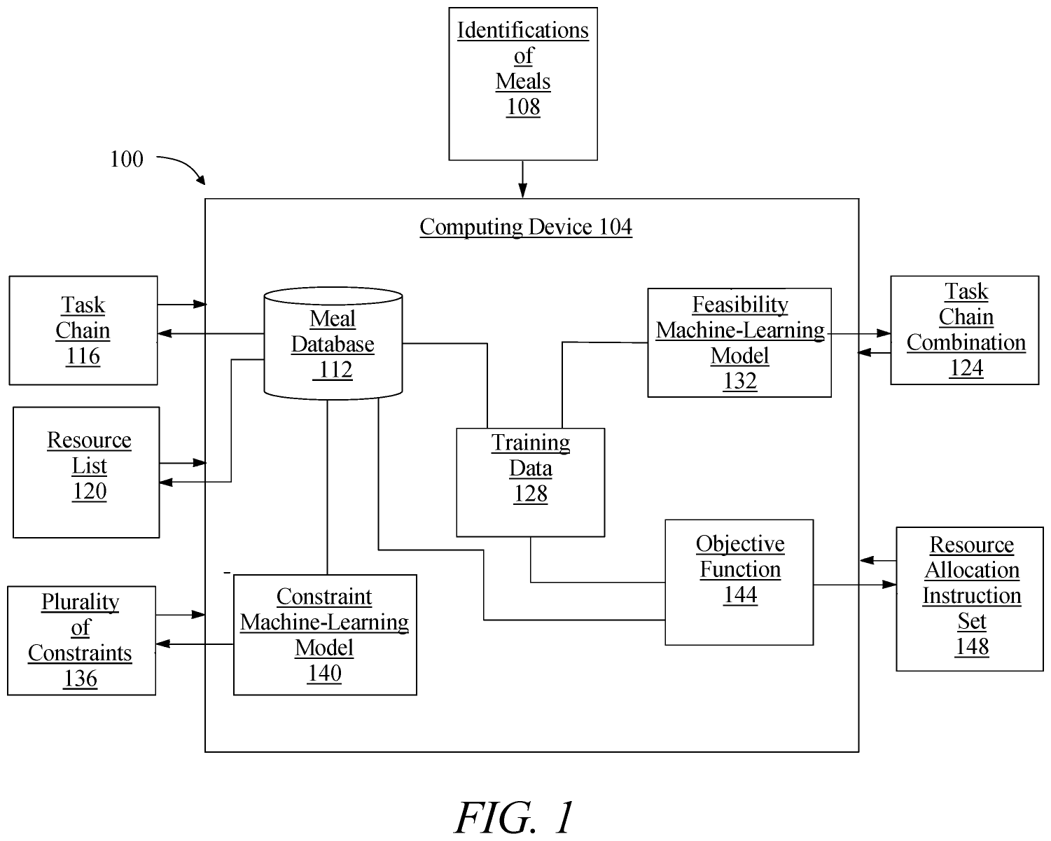

Referring now to FIG. 1, an exemplary embodiment of a system 100 for determining resource allocation instruction set for meal preparation using a machine-learning process is illustrated. System includes a computing device 104. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. computing device 104 may include one or more computing devices dedicated to data storage, security, distribution of traffic for load balancing, and the like. computing device 104 may distribute one or more computing tasks as described below across a plurality of computing devices of computing device, which may operate in parallel, in series, redundantly, or in any other manner used for distribution of tasks or memory between computing devices. computing device 104 may be implemented using a “shared nothing” architecture in which data is cached at the worker, in an embodiment, this may enable scalability of system 100 and/or computing device.

Computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Continuing in reference to FIG. 1, computing device 104 is configured to receive a plurality of identifications of meals 108 to be prepared. Receiving a plurality of identifications of meals 108 may include retrieving an ingredients list correspond to a plurality of meals may be received by computing device 104 by a user, menu, recipe, online repository, database or the like. In non-limiting illustrative embodiments, computing device 104 may retrieve, upload, or the like a menu, plurality of recipes, meal set, and the like, and retrieve ingredients corresponding to a plurality of meals; computing device 104 may prompt a user to eliminate ingredients and/or include missing ingredients from the list. In further non-limiting examples, ingredient lists may be stored and/or retrieved from a database, organized for instance in tables based on relationship of a menu item to an ingredient list. A database as described in this disclosure may refer to a “meal database,” as described in further detail below. Meal database 112 may include a variety of data that can be stored and/or retrieved by computing device 104, as described in further detail below. A plurality of identifications of meals 108 as described in this disclosure may refer to a menu, list of recipes, list of ingredients, supplements, or any other suitable information for preparing an edible arrangement. In non-limiting illustrative examples, a plurality of identifications of meals may include a restaurant menu with a variety of items that require different levels of manipulation to achieve a final product.

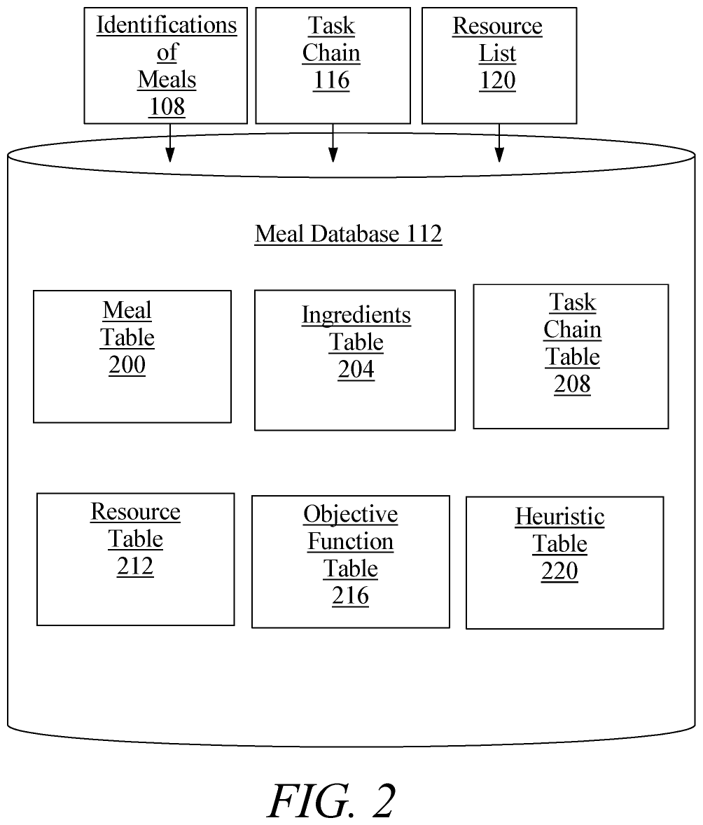

Referring now to FIG. 2, a non-limiting exemplary embodiment of a meal database 112 is illustrated. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Database may refer to a “meal database” which at least a computing device 104 may, alternatively or additionally, store and/or retrieve data from, without limitation, a meal table 200, ingredients table, 204 task chain table 208, resource table 212, objective function table 216, and/or heuristic table 220. Determinations by a machine-learning process may also be stored and/or retrieved from the meal database 112, for instance in non-limiting examples a classifier describing a subset of data, as described in further detail below. Determinations by an objective function or for optimization of an injective function may also be stored and/or retrieved from the meal database 112, for instance in non-limiting examples a function for optimizing steps in a task chain to prepare a certain meal, as described in further detail below. As a non-limiting example, meal database 112 may organize data according to one or more instruction tables. One or more meal database 112 tables may be linked to one another by, for instance in a non-limiting example, common column values. For instance, a common column between two tables of meal database 112 may include an identifier of a submission, such as a form entry, textual submission, research paper, or the like, for instance as defined below; as a result, a query may be able to retrieve all rows from any table pertaining to a given submission or set thereof. Other columns may include any other category usable for organization or subdivision of expert data, including types of expert data, names and/or identifiers of experts submitting the data, times of submission, or the like; persons skilled in the art, upon reviewing the entirety of this disclosure, will be aware of various ways in which data from one or more tables may be linked and/or related to data in one or more other tables.

Still referring to FIG. 2, in a non-limiting embodiment, one or more tables of a meal database 112 may include, as a non-limiting example, a meal table 200, which may include menu items, recipes, and the like, for use in determining ingredients lists, calculating resources, and the like, correlating meal data to other tables, entries indicating degrees of relevance to and/or efficacy in predicting a task chain, steps of a plurality of task chains, and/or other elements of data computing device 104 and/or system 100 may use to determine usefulness and/or relevance of meal data in determining task chains, resource constraints, preparation time, and/or changes in task chains as described in this disclosure. One or more tables may include an ingredients table 204, which may include a history of ingredients corresponding to a plurality of meals, for instance and without limitation, that a meal has incorporated, obtained, substituted, may still left to be added to a meal, and other identifying information linked to the attainment of ingredients, for instance the number, type, and presence of ingredients in preparing a meal, location of ingredient, storage, preparation, use, and length of time to prepare, and an ingredient's association with a second ingredient, among other information. One or more tables may include a task chain table 208, which may correlate meal data, objectives, outcomes, models, heuristics, and/or combinations thereof to one or more measures of preparing a meal. One or more tables may include, without limitation, a resource table 212 which may contain one or more inputs identifying one or more categories of data, for instance numerical values describing the number and type of personnel available, personnel work shifts, appliances, utensils, training, delivery methods, ingredient logistics, establishment operation, relationships associated between two or more resources, their use, and the like. One or more tables may include, without limitation, an objective function table 216 which may contain one or more inputs identifying one or more categories of data, for instance delivery data, ordering data, timing data, resource data, or the like, with regard to optimization and generation of objective functions and/or task chains as a result of, for instance and without limitation, a ranking process for outputting elements and/or other user data input elements. One or more tables may include, without limitation, a heuristic table 220, which may include one or more inputs describing potential mathematical relationships between at least an element of user data and objectives, instructions, and rankings thereof, change in objectives and/or instructions over time, and/or ranking functions for determining a rank-ordered set of objectives and/or instructions, as described in further detail below.

Continuing in reference to FIG. 1, computing device 104 may retrieve a plurality of task chains 116, wherein retrieving a task chain 116 may include retrieving, for each meal of the plurality of meals, a task chain 116 identifying a plurality of sequentially ordered tasks for preparation of the meal. A “task chain,” as described in this disclosure, is a task, or series of tasks, that may be performed in preparation of a meal. A task chain may be provided by a user, such as a restaurant, cook, or the like, and task chains may be stored and/or retrieved by computing device 104 from a meal database 112, for instance from a task chain table 208. Alternatively or additionally, computing device 104 may retrieve task chains from an online repository or other suitable source for retrieving information regarding meal preparation. In non-limiting illustrative examples, a task chain may contain sequentially ordered tasks that may be sequentially ordered based upon a chronological order, tasks ordered by resource optimization, task ordered by customer priority, and the like. A task chain may contain elements, steps, instructions, or the like that refer to preparing one or more meals, by one or more personnel, using one of more stations, appliances, utensils, and the like. Computing device 104 may store and/or retrieve a task chain 116, or an element of an existing task chain 116 to form a new task chain 116, from a meal database 112, online repository, blog, culinary website, or any other suitable source, as described above. In non-limiting illustrative examples, a computing device may retrieve a plurality of task chains 116 by retrieving a series of steps corresponding to an identification of meal 108, for instance and without limitation, recipe steps using available ingredients for cooking a beef stew. In further non-limiting illustrative examples, the steps to a beef stew may be associated with a chronological sequential ordering of personnel tasks, ingredient retrieval, kitchen space use, and may differ based upon time constraints, including and/or avoiding certain ingredients, equipment, and the like.

Continuing in reference to FIG. 1, computing device 104 may retrieve a plurality of task chains 116, wherein retrieving may include identifying, for each task chain 116, a resource list 120 identifying a plurality of resources, wherein each resource is associated with a task of the plurality of sequentially ordered tasks. A “resource list,” as described in this disclosure refers to a tabulation, list, or the like, of ingredient identities, amounts, and expirations; kitchen stations, equipment, appliances, utensils, dishware, personnel, operating hours, tables, customers; delivery couriers including restaurant employees and secondary couriers via application services, ‘gig’ economy services, and the like; delivery vehicles, including cars, trucks, bikes, and the like, and any other suitable resource relating the preparation of a meal, delivery of a meal, and/or meal orders. Computing device 104 may determine a resource and tabulate, list, group, or otherwise categorize a plurality of resources by retrieving a resource form a database, as described above. Alternatively or additionally, a resource of a resource list 120 may be stored and/or retrieved from a database by a machine-learning process, such as a first machine-learning model, as a resource may correspond to a plurality of meals, ingredients, task chains, or the like.

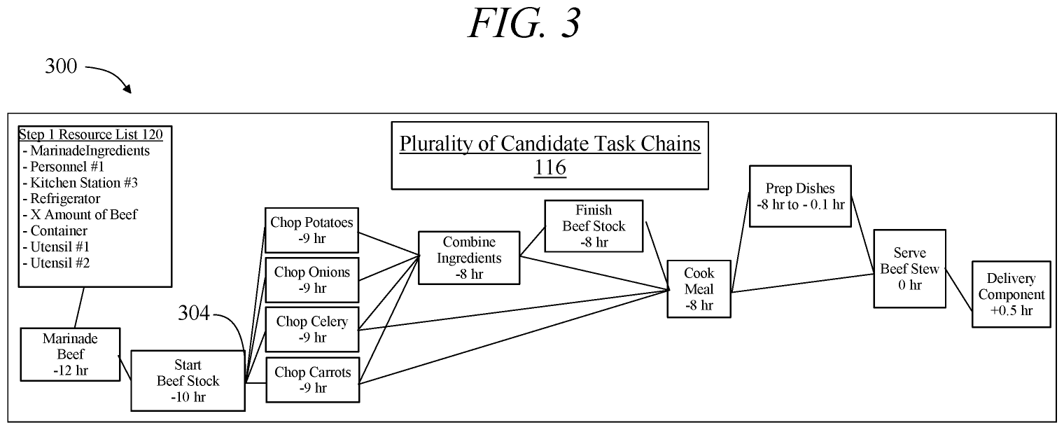

Referring now to FIG. 3, an exemplary embodiment 300 of a plurality of task chains 116 and associated resource list 120 is illustrated. Task chains may differ at branching points 304 that correspond to different pathways, series of elements, steps, or the like in preparing a meal. In non-limiting illustrations a branch point 304 may represent places where deviations in tasks in a task chain may differ for instance, omitting or including a step to eliminate or add a new ingredient, for instance removing onions from the beef stew upon customer request, or customizing meal by adding chives. In further non-limiting illustrative examples, branch point 304 may represent a place in a task chain where concurrently performed steps are added, subtracted, combined, or split into new task chains 116. For instance and without limitation, FIG. 3 illustrates a branch point 304 wherein after beginning preparation of a beef stock for a meal, a first kitchen personnel may include next any series of vegetables, beginning with any of the four, before moving to a next task in the task chain 116. In such an example, several task chain 116 modification may be introduced at branch point 304, for instance and without limitation, a second kitchen personnel may be added to assist in the ingredient preparation steps to decrease time of meal preparation, or a fifth ingredient may be added upon request to customize a meal further, resource permitting. Task chains may be listed in a sequentially ordered manner and mapped to the anticipated timescale for preparing a meal; timescale may be altered by applying different resource lists 120 to different steps in a task chain 116 and/or modifying the task chain by adding/subtracting branch points, removing/adding tasks, and the like. For instance and without limitation, the plurality of task chains 116 illustrated in FIG. 3 are mapped to a 12-hr time scale for preparing a beef stew, wherein a negative time value represents “time out” from a meal being finished, and a positive time value represents “time post preparation,” including for example delivery time, customer retrieval time, and the like. Task chains may be optimized, combined, and or otherwise modified as described in further detail below to decrease average time of preparation.

Referring again to FIG. 1, computing device 104 may generate a plurality of candidate task chain combinations 124, wherein each task chain combination may include a first task chain of the plurality of task chains and a second task chain of the plurality of task chains, and a first task of the first task chain and a second task of the second task chain are concurrently performed using a resource associated with each of the first task and the second task. A first task of a first task chain and a second task of a second task chain may be placed in a sequentially ordered sequence and/or performed concurrently relative to each other depending on constraints on task ordering and/or combination. For instance, a first task of a first task chain may be to prepare a first meal at a station and a second task of a second task chain may be to prepare a second meal, wherein the first meal introduces an allergen to be excluded from the second meal; this would introduce a constraint that would limit the sequential ordering in this manner. In such an example, the sequential order of the two different task chains would need to be changed based on avoiding said allergen. In further non-limiting illustrative examples, a first task of a first task chain may be to prepare 1 cup of a first ingredient and a second task of a second task chain may be to prepare 1 cup of that same ingredient, a first task of a first task chain and a second task of a second task chain may be combined concurrently to improve efficiency, wherein a single person may prepared 2 cups at once. Determining if any constraint exists may include determining if a constraint would limit a first task of a first task chain being ordered followed by a second task in a second task chain in either a sequential and/or concurrent ordering. If either task chain ordering is determined to be allowed based upon constraints, then ordering of a plurality of task chains may be added to a feasible list for further feasibility quantifier analysis, as described in further detail below. In non-limiting illustrative examples, a plurality of task chains 116 may be concurrently listed, for instance combined into a plurality of candidate task chain combinations 124 determined by sequentially listing certain tasks and concurrently performing other tasks within a potential combination of task chains, wherein concurrently performed tasks overlap at least for a moment in time, personnel, station, equipment, or overlap in any resource, as described above. In further non-limiting illustrative examples, concurrently performed tasks of two task chains may involve, for instance and without limitation, a combination of resource at once such as preheating an oven of a first task chain, washing utensils to remove allergens of a second task chain, and chopping vegetables of a third task chain. In such a non-limiting example, a first task chain may correspond to preparing two distinct meals, such as a second meal and third meal, each of which may require heating in an oven at the same temperature, or at an average temperature suitable for both meals while using a single oven, wherein the average temperature is an optimized temperature calculated by a machine-learning model and/or objective function to batch cooking steps together, as described in further detail below; a second task chain may correspond to removing allergens from a first meal that can be done while preparing a second meal and a third meal, but must be completed prior to finishing the preheating stage; a third task chain may correspond to chopping vegetables that may correspond to an ingredient preparation task that overlaps with a plurality of meals.

Continuing in reference to FIG. 1, tasks chains 116 and candidate task chain combinations 124 may include signifiers, numerical values, alphanumerical codes, and the like that contain elements of data regarding identifiers related to certain combinations of task chains elements, resource amounts, time amounts, constraints, and/or any other identifiable parameters that may be used in determining feasibility of a task chain, or plurality of task chain combinations, as described in further detail below. A machine-learning model may, for instance, retrieve a task chain 116 from a meal database 112 and determine feasibility of said task chain 116 by identification by a signifier, as described above.

Continuing in reference to FIG. 1, computing device 104 may identify a plurality of constraints 136 as a function of identifications of meals, which may include at least a resource constraint and at least a timing constraint. A “constraint,” as used herein refers to a barrier, limitation, consideration, or any other constraint pertaining to resource utilization during optimizing the combination of a plurality of task chains that may arise during meal preparation and/or delivery as a function of performing a plurality of task chains combinations, wherein the constraint may alter the time and/or resources available to preparing a meal or performing a task, may alter the concurrent and/or sequential ordering of tasks in a plurality of task chains, and/or may alter the feasibility of combining a plurality of task chains. Constraints may be identified by an optimization process during optimization of task chain combinations 124, as described in further detail below. A constraint may, for instance and without limitation, only appear during a particular optimized listing of a plurality of task chain elements, wherein a second listing of the same elements in a different ordering may not show the same constraint. In non-limiting illustrative examples, a constraint may be a resource constraint, wherein dedicating an individual to a series of tasks for preparing a meal would then place a constraint on preparing a second meal with said individual, or performing a second combination of task chains; likewise a constraint may be a time constraint wherein the maximal time allotted for selecting task chains for an individual or set of individuals working in tandem in preparing a meal may be dictated by when a customer places an order, whether a customer is dine-in or take-out, delivery method for the meal, and/or type of meal and ingredients used. Constraints may refer to customer preferences, for instance and without limitation, such as the presence of allergies, food intolerances, hypersensitivities, or other dietary constraints, philosophical, religious, and/or moral considerations to ingredients and/or meal preparation, and the like; constraints may refer to seasonality of ingredients, ingredient amounts, ingredient substitutions, and/or other material and immaterial constraints to ingredient availability and use. Such information may be stored and/or retrieved by a computing device 104 from a database, for instance, via orders input by a restaurant wait staff, logged by a web based application, mobile application, or other meal ordering service, application, device, of the like. Meal orders may be provided in a non-electronic format and task chains 116 retrieved after a user prompts a computing device 104 for task chains 116 associated with an order, which may contain constraint information. Constraint information may be stored and/or retrieved alongside task chain 116 information by use of an alphanumeric code, numerical value, or any other method of signifying the presence, amount, and/or nature of a constraint related to a task, task chain 116, and/or combinations of task chains 116.

Continuing in reference to FIG. 1, computing device 104 may be configured to generate plurality of candidate task chain combinations 124 by receiving feasibility training data 128. Feasibility training data 128 may include a plurality of entries correlating task combinations with feasibility quantifiers. A “feasibility quantifier,” as used in this disclosure is a score, metric, function, vector, matrix, numerical value, or the like, which describes a qualitative and/or quantitative mathematical proportion, propensity, or any relationship correlating the likelihood, possibility, and/or probability of completing a task, given a set of constraints and the a task's relationship in time to and ordering to other tasks, within a particular timeframe, wherein a timeframe may be determined by an identification of a meal 108, meal preparation time, expected delivery time, resource list 120, task chain 116, and the like. Computing device 104 may identify feasible combinations based on various constraints, wherein computing device 104 may find and/or set values for those constraints or add a new constraint in the form of a “feasibility quantifier”. In non-limiting illustrative examples, a feasibility quantifier may include scores relating the probability of feasibility for completing a series of tasks, wherein each task has an associated probability in relating preparation of a beef stew related to preparing the beef stew for a customer order within, for instance, a 15-minute time frame, 30-minute time frame, 1-hour time frame, etc. In further non-limiting illustrative examples, task chain steps that would require more than a 15-minute time frame would garner scores indicating lower levels of feasibility, such as for instance from the example in FIG. 3, placing beef in a marinade, chopping vegetables, and cooking a beef stock, and thus may result in candidate task chain steps that would sequentially order meal preparation of such steps for a suitable amount of time prior to the 15-minute time frame. Additionally, in non-limiting illustrative examples, task chain steps that could be completed within the 15-minute time frame of ordering may include combining the ingredients, and plating the meal, which would garner higher feasibility scores resulting in task chain elements that may be combined in such a way that allows an individual to complete the entire task chain combination to fulfill orders within 15 minutes of the customer placing the order. Feasibility quantifiers may be stored and/or retrieved from a database. Alternatively or additionally, determining the feasibility of a task chain may include resource constraint information, as described in further detail below, wherein the feasibility of an individual completing a first candidate task chain combination 124 depends upon if that same individual is dedicated to a second candidate task chain combination 124, and if the suitable kitchenware, utensils, appliances, workstations, and the like, are in use and/or if preparation of the next meal may result in an biological and/or philosophical conflict for a customer, for instance an allergy to peanuts, a lactose-free meal after cooking with milk, Kosher preparation, or a vegan meal. Feasibility quantifiers may incorporate information, for instance, if there would be enough time to prepare a second meal after a first meal, if a second meal would demand decontamination of a common space to avoid antigen cross-contamination. In such a non-limiting illustrative example, a feasibility quantifier may rank a candidate task chain combination 124 in such a way that gave a more favorable score to preparing a second meal first, followed by a first meal, as described in further detail below.

Continuing in reference to FIG. 1, “training data,” as used herein, is data containing correlations that a machine-learning process may use to model relationships between two or more categories of data elements. For instance, and without limitation, training data 128 may include a plurality of data entries, each entry representing a set of data elements that were recorded, received, and/or generated together; data elements may be correlated by shared existence in a given data entry, by proximity in a given data entry, or the like. Multiple data entries in training data 128 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 128 according to various correlations; correlations may indicate causative and/or predictive links between categories of data elements, which may be modeled as relationships such as mathematical relationships by machine learning processes as described in further detail below. Training data 128 may be formatted and/or organized by categories of data elements, for instance by associating data elements with one or more descriptors corresponding to categories of data elements. As a non-limiting example, training data 128 may include data entered in standardized forms by persons or processes, such that entry of a given data element in a given field in a form may be mapped to one or more descriptors of categories. Elements in training data 128 may be linked to descriptors of categories by tags, tokens, or other data elements; for instance, and without limitation, training data 128 may be provided in fixed-length formats, formats linking positions of data to categories such as comma-separated value (CSV) formats and/or self-describing formats such as extensible markup language (XML), enabling processes or devices to detect categories of data.

Alternatively or additionally, training data 128 may include one or more elements that are not categorized; that is, training data 128 may not be formatted or contain descriptors for some elements of data. Machine learning algorithms and/or other processes may sort training data 128 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine learning algorithms, and/or automated association of data in the data entry with descriptors or into a given format. The ability to categorize data entries automatedly may enable the same training data 128 to be made applicable for two or more distinct machine learning algorithms as described in further detail below. Training data 128 used by computing device 104 may correlate any input data as described in this disclosure to any output data as described in this disclosure. Training data may contain entries, each of which correlates a machine learning process input to a machine learning process output, for instance without limitation, one or more elements of meal ingredients to a task chain. Training data may be obtained from previous iterations of machine-learning processes, database, user inputs, and/or expert inputs. Training a machine-learning model using training data may be performed using a machine learning module, as described in further detail below.

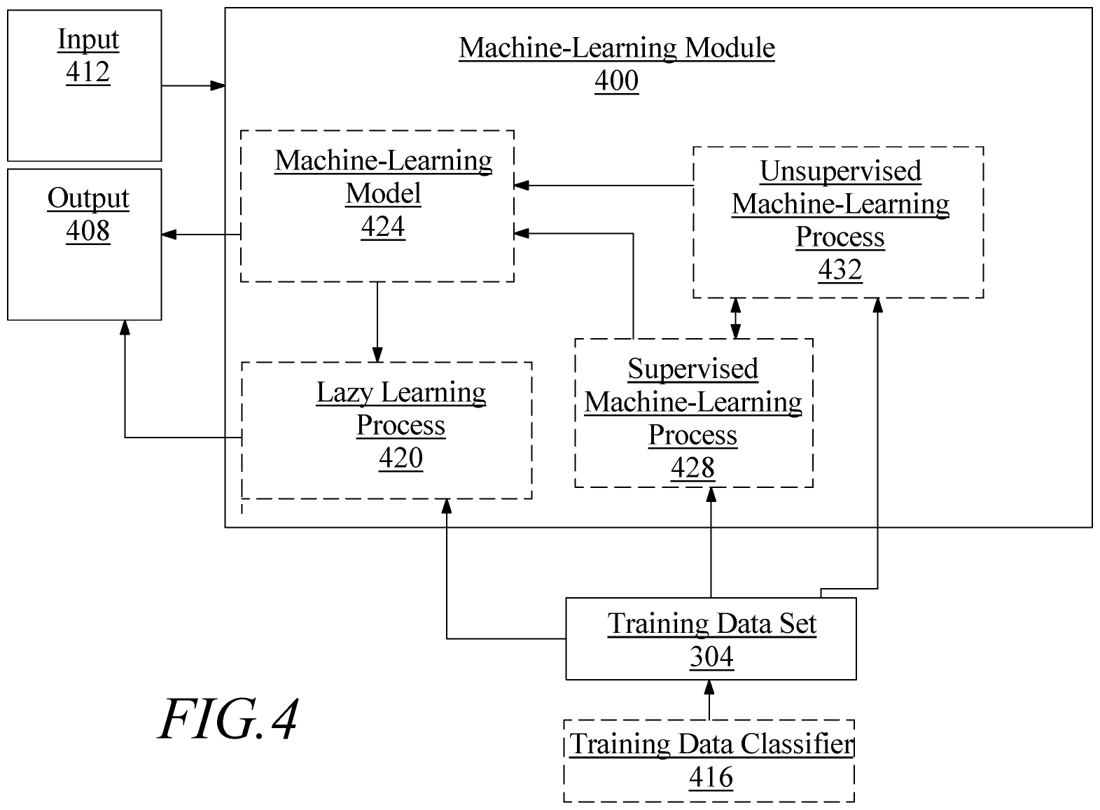

Referring now to FIG. 4, an exemplary embodiment of a machine-learning module 400 that may perform one or more machine-learning processes as described in this disclosure is illustrated. Machine-learning module may include any suitable machine-learning module which may perform determinations, classification, and/or analysis steps, methods, processes, or the like as described in this disclosure using machine learning processes. A “machine learning process,” as used in this disclosure, is a process that automatedly uses training data set 404 containing training data 128 to generate an algorithm that will be performed by a computing device/module to produce outputs 408 given data provided as inputs 412; this is in contrast to a non-machine learning software program where the commands to be executed are determined in advance by a user and written in a programming language.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 400 may generate a classifier using a classification algorithm, defined as a process whereby a computing device and/or any module and/or component operating thereon derives a classifier from training data set 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to a plurality of task chain, such as a cohort of persons and/or other analyzed items and/or phenomena for which a subset of training data may be selected].

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data set 404. Heuristic may include selecting some number of highest-ranking associations and/or training data set 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model 424,” as used in this disclosure, is a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data set 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include identifications of meals 108 as described above as inputs, plurality of task chains 116 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data set 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Still referring to FIG. 4, models may be generated using alternative or additional artificial intelligence methods, including without limitation by creating an artificial neural network, such as a convolutional neural network comprising an input layer of nodes, one or more intermediate layers, and an output layer of nodes. Connections between nodes may be created via the process of “training” the network, in which elements from a training data set 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. This network may be trained using training data set 404.

Referring again to FIG. 1, computing device 104 may train a feasibility machine-learning model 132 using the feasibility training data 128 and generate a feasibility quantifier as a function of the feasibility machine-learning model 132, the first task, and the second task. In non-limiting illustrative examples, a feasibility score may be generated by a machine-learning process using training data 124. For instance and without limitation, training data 124 may include a plurality of meals, customer preferences, and available resources to generate a model that describes a feasibility quantifier for scoring meals for the purpose of allergen avoidance. In further non-limiting illustrative examples, a feasibility machine-learning model 132 may be trained with data that includes available resource capabilities, as described above, to output a model that may measure, calculate, weight, rank, or otherwise determine the feasibility of completing a first task as it relates to performing a second task, wherein completing and/or performing a first task may deplete, occupy, or otherwise use resources available for a second task, thereby having a quantitative and/or qualitative effect on the feasibility of a second task. A feasibility quantifier may then score and/or rank performing a first task followed by a second task versus a second task followed by a first task accordingly, resulting in two distinct task chain combinations ranked by their feasibility; the feasibility may increase between, decrease between, or remain the same between the two task chains.

Continuing in reference to FIG. 1, identification of plurality of constraints 136 may include using a constraint machine-learning model 140 and a first plurality of candidate task chain combinations 124 to determine if a constraint exists, and measuring the effect of the constraint on a candidate task chain. The constraint machine-learning model 140 may accept an input of a plurality of candidate task chain combinations 124 and calculate, measure, and/or otherwise determine if a constraint in resources arises between performing steps of the plurality of candidate of task chains combinations 124 and generate an output of at least a constraint of a plurality of constraints 136. For instance, in non-limiting illustrative examples, a constraint machine-learning model 140 may calculate the amount of an ingredient that is being depleted from a restaurant's stock of that ingredient as meals are prepared, and modify a task chain to include a procurement step for that ingredient based upon the anticipated time for procuring the ingredient and the time until the ingredient is fully depleted. In such an example, a constraint machine-learning model 140 may measure the rate of depletion of an ingredient with each task chain expressed as a function of time, and then iteratively compare this rate to the calculated amount of ingredient left and the time required to replenish the ingredient to measure the nature of the constraint. Outputs from a constraint machine-learning model 140 may be stored and/or retrieved from a meal database 112.

Continuing in reference to FIG. 1, computing device 104 may select a candidate chain task combination 124 of the plurality of task chain combinations 124 that satisfies the plurality of constraints, which may include generating an objective function 144 of the plurality of candidate task combinations 124. An “objective function,” as used in this disclosure, is a mathematical function with a solution set including a plurality of data elements to be compared, such as without limitation plurality of candidate task chain combinations. Objective function generates an output scoring candidate task chain combinations according to at least a goal criterion, which may include any criterion as described in further detail below. computing device 104 may compute a score, metric, ranking, or the like, associated with each candidate task chain 116 and or plurality of candidate task chains 116 and select objectives to minimize and/or maximize the score, depending on whether an optimal result is represented, respectively, by a minimal and/or maximal score; an objective function may be used by computing device 104 to score each possible pairing. An objective function 144 may be based on one or more objectives, as described below. Computing device 104 may pair a predicted meal, with a given combination of candidate task chain combinations 124, that optimizes the objective function. In various embodiments a score of a candidate task chain combination 124 may be based on a combination of one or more factors, including a plurality of constraints 136. Each factor may be assigned a score based on predetermined variables. In some embodiments, the assigned scores may be weighted or unweighted, for instance and without limitation as described in the U.S. Nonprovisional application Ser. No. 16/890,686, filed on Jun. 2, 2020, and entitled “ARTIFICIAL INTELLIGENCE METHODS AND SYSTEMS FOR CONSTITUTIONAL ANALYSIS USING OBJECTIVE FUNCTIONS,” the entirety of which is incorporated herein by reference.

Optimization of an objective function 144 with a solution set including the plurality of candidate task chain combinations may include performing a greedy algorithm process, where optimization is performed by minimizing and/or maximizing an output of objective function through selection of inputs such as task combinations. A “greedy algorithm” is defined as an algorithm that selects locally optimal choices, which may or may not generate a globally optimal solution. For instance, computing device 104 may select objectives so that scores associated therewith are the best score for each goal. For instance, in non-limiting illustrative example, optimization may determine the combination of routes for a courier such that each delivery pairing includes the highest score possible, and thus the most optimal delivery.

Still referring to FIG. 1, objective function 144 may be formulated as a linear objective function, which computing device 104 may optimize using a linear program such as without limitation a mixed-integer program. A “linear program,” as used in this disclosure, is a program that optimizes a linear objective function, given at least a constraint; a linear program maybe referred to without limitation as a “linear optimization” process and/or algorithm. For instance, in non-limiting illustrative examples, a given constraint might be personnel constraint, and a linear program may use a linear objective function to calculate minimized caloric intake for weight loss without exacerbating a nutritional deficiency. In various embodiments, system 100 may determine a set of instructions towards achieving a user's goal that maximizes a total score subject to a constraint that there are other competing objectives. A mathematical solver may be implemented to solve for the set of instructions that maximizes scores; mathematical solver may be implemented on computing device 104 and/or another device in system 100, and/or may be implemented on third-party solver.

With continued reference to FIG. 1, generating an objective function of the plurality of candidate task chain combinations may include minimizing a loss function, where a “loss function” is an expression an output of which a ranking process minimizes to generate an optimal result. As a non-limiting example, computing device 104 may assign variables relating to a set of parameters, which may correspond to score components as described above, calculate an output of mathematical expression using the variables, and select an objective that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs

Continuing in reference to FIG. 1, computing device 104 may select a candidate task chain combination 124 for which the output of the objective function indicates a maximal satisfaction of the at least a goal criterion; a maximal satisfaction of at least a goal criterion may be determined by optimizing objective function, either by minimizing an output of an objective function formulated to represent more desirable inputs using smaller outputs, such as a loss function, and/or maximizing an output of an objective function formulated to represent more desirable inputs using larger outputs. In non-limiting illustrative examples, objective function 144 may be optimized, for instance, by minimizing time for meal preparation given a plurality of candidate task chain combinations 124, wherein the optimized objective function may rank the candidate task chain combination 124 based upon the average meal preparation time for each task chain combination as a function of the resource constraints that arise.

Continuing in reference to FIG. 1, computing device 104 may select a candidate task chain combination 124 by using an objective function 144 to rank candidate task chain combinations 124 in preparing a plurality of meals. Ranking candidate task chain combinations 124 may be performed as a function of average meal preparation time as a function of the resource constraints output by a constraint machine-learning model 140. Ranking may be performed by a variety of factors, including for instance and without limitation, ranking based on resource depletion, availability, energy cost, preparation time, personnel use, customer allergies, religious, philosophical, and moral preferences, and the like. Task chains 116 may be selected based upon the ranking criteria determined by the objective function optimized by the plurality of task chain combinations 124 input.

Continuing in reference to FIG. 1, computing device 104 may generate and/or the objective function 144 of the plurality of candidate task chain combinations 124 by performing linear optimization. A linear optimization program that optimizes a linear objective function may accept an input that is, for instance and without limitation, a customer preference constraint of a peanut allergy as a function of the plurality of meals that a restaurant would prepare. Linear optimization may be performed to minimize preparation steps using kitchenware, utensils, stations, and the like within the restaurant while minimizing average time of meal preparation for both the meals with peanuts and without peanuts. Such a linear optimization performed may, for instance in non-limiting illustrative examples, be provided a series of constraints such as a personnel constraint, kitchen station constraint, and time constraint, and a linear objective function may optimize the objective function in determining the optimal task chains, given the constraints, to prepare a plurality of meals in a minimal amount of time.

Continuing in reference to FIG. 1, computing device 104 may generate and/or the objective function 144 of the plurality of candidate task chain combinations 124 by performing mixed integer optimization. Which computing device 104 may solve using a linear program such as without limitation a mixed-integer program, as described above. For instance, and without limitation, optimizing the objective function may include seeking to maximize a total score Σ_{r∈R} Σ_{s∈S} cᵣₛxᵣₛ, where R is the set of all task chains r, S is a set of all meals s, cᵣₛ is a score of a pairing of a given task chain 116 with a given meal, and xᵣₛ is 1 if a task chain r is paired with meal s, and 0 otherwise, for instance and without limitation as determined using feasibility analysis and/or application of one or more constraints as described above. Continuing the example, constraints may specify that each task chain 116 is assigned to only one meal, and each meal is assigned only one task chain 116; meals may include compound task chains 116, as described above. Sets of task chains 116 may be optimized for a maximum score combination of all generated task chains 116. In various embodiments, system 100 may determine a plurality of candidate task chain 116 combinations 124 that maximizes a total score subject to a constraint that all meals of a plurality of meals are paired to at least one task chain 116. Not all couriers may receive a route pairing since each delivery may only be delivered by one courier. A mathematical solver may be implemented to solve for the set of feasible pairings that maximizes the sum of scores across all pairings; mathematical solver may implemented on computing device 104 and/or another device in system 100, and/or may be implemented on third-party solver.

Mixed integer optimization may include mixed integer linear optimization, mixed integer convex optimization, mirror-descent methods, mixed integer nonlinear optimization, and the like. In non-limiting illustrative examples, mixed integer optimization may be used wherein a series of variables are optimized based on numerical values assigned to each variable within a system of linear equations, for instance a chronological number assigned to steps in a series of a plurality of candidate task chain combinations 124, resource constraints 136, a plurality of meals orders, and time associated with completing each step and a function of the tasks performed concurrently, prior, and after a task. In non-limiting illustrative examples, one set of variables may be task chain 116 steps and a second set of variables may be time for completing a series of steps, wherein the second set of variables has a continuous scale that extends from a minimally feasible time to a maximal meal preparation time, and wherein selecting a particular order or combination of task chains 116 will alter the average time of preparing a series of meals. In further non-limiting illustrative examples, an objective function for ranking, or otherwise selecting, a plurality of candidate task chain combinations 124 may be optimized for selecting the task chain 116 combinations based on minimizing the average time of meal preparation for a plurality of meals, as meals are updated and completed.

Continuing in reference to FIG. 1, computing device 104 may generate and/or optimize the objective function using and/or as a loss function, wherein the objective function may include a solution set including the plurality of candidate task chain combinations by minimizing the loss function. The objective function may include a loss function and achieving a maximal satisfaction of a goal criterion with the objective function 144 may include minimizing the loss function, wherein a “loss function” is an expression an output of which an optimization algorithm minimizes to generate an optimal result, as described above. As a non-limiting example, computing device 104 may assign variables relating to a set of parameters, which may correspond to score components as described above, calculate an output of mathematical expression using the variables, and select a pairing that produces an output having the lowest size, according to a given definition of “size,” of the set of outputs representing each of plurality of candidate task chain combinations 124; size may, for instance, include absolute value, numerical size, or the like. Selection of different loss functions may result in identification of different potential pairings as generating minimal outputs. Objectives represented in an objective function 144 and/or loss function may include minimization of meal preparation times as a function of constraints. Objectives may include minimization of average meal preparation time by kitchen personnel at kitchen stations, for instance, maximizing batching ingredient preparation for a plurality of meals to minimize time for preparing meals; meal preparation times may depend, for instance and without limitation, on meal constraints, as described above. Objectives may include minimization of meal preparation times in excess of estimated or requested arrival times.

Continuing in reference to FIG. 1, computing device 104 may determine a solution set including the plurality of candidate task chain combinations 124 with regard to average preparation time using the generated objective function 144. For instance and without limitation, optimizing the objective function 144 may include iteratively calculating the difference between expected retrieval time and expected time of completion. Retrieval time may be determined using the route optimization for couriers, wherein the retrieval time is attributable to expected time of completion for when meal is ready for retrieval, for instance and without limitation, by a customer or a delivery driver. An objective function 144 may be optimized on minimizing time differences to measure the efficiency of task chains that result in delivery and rank them accordingly, for instance and without limitation as described in U.S. Nonprovisional application Ser. No. 16/890,839, filed on Jun. 2, 2020, and entitled “METHODS AND SYSTEMS FOR PATH SELECTION USING VEHICLE ROUTE GUIDANCE,” the entirety of which is incorporated herein by reference.

Continuing in reference to FIG. 1, computing device 104 may generate an output of scoring candidate task chain combinations 124 according to at least a goal criterion by scoring with regard to difference between an expected retrieval time and an expected time of completion using the objective function 144. The objective function 144 may be optimized by measuring, finding, calculating, or otherwise determining the difference in time between when a meal is to be, for instance and without limitation, delivered, picked-up by a customer, or served to a customer at a restaurant, and when meal preparation is to be completed. Objective function 144 may result in re-ranking task chains 116 of a plurality of selected task chain combinations 124 based upon these calculating. For instance in non-limiting examples, objective function 144 may re-rank task chains 116 if time can be minimized such that a meal may be prepped closer in time to when a customer might arrive to retrieve it. In further non-limiting examples, objective function 144 may be optimized to prioritize task chains 116 based upon an eminent resource shortage that will increase the difference between expected retrieval time and expected time of completion.

Continuing in reference to FIG. 1, computing device 104 may generate a resource allocation instruction set 148 as a function of the optimized objective function 144 and/or selected task chain combination. A resource allocation instruction set 148 may include a tabulation of all resources necessary for completing a plurality of task chain combinations 124 which may have been generated and then ranked based upon constraints and/or feasibility. For instance, an objective function 144 may be optimized, as described above, to rank task chain 116 elements in a combination of task chains 124 as it relates to resource lists 120, feasibility, and with regard to calculated differences between expected retrieval time and expected time of completion to rank, score, or otherwise prioritize task chains 116 with the plurality of task chain combinations 124 to generate a prioritized task chain combination. A resource allocation instruction set 148 may include a prioritized task chain combination, which has been prioritized based on chronological prioritization, among other prioritizations, that results in a series of steps, instructions, or the like, that may be communicated to kitchen personnel, delivery personnel, and/or customers. Resource allocation instruction set 148 may include signifiers, numerical values, alphanumerical codes, and the like that contain elements of data regarding feasibilities, resource amounts, time amounts, constraints, and/or any other identifiable parameters that may be used in determining a prioritized task chain combination for a plurality of meals. Resource allocation instruction sets 148 and the above associated data may then be stored and/or retrieved from a database for device communication to users, for instance restaurant staff, delivery drivers, and the like, and/or for subsequent task chain generation, modification, resource calculation, instruction generation, and the like. In non-limiting illustrative examples, a resource allocation instruction set 148 may include task chain instructions for kitchen personnel that correspond to the preparation of a plurality of meals, wherein delivery personnel may receive elements of a combination of task chains that is pertinent to the delivery of a particular meal, and a customer may only receive a single task chain instruction to “pick up meal” and/or “meet delivery personnel” corresponding to the appropriate time to do so associated with the meal ordered. In such an example, the resource allocation instruction set 148 combines instructions for all parties involved in completing meal preparation and delivery in the quickest way feasible, while also maintaining data relating to the resources used and outstanding constraints, conflicts, of the like, that were avoided, or may still arise. Computing device 104 may store and/or retrieve resource allocation instruction sets 148 in a meal database 112 for subsequent use, for instance and without limitation, if a rush hour of a lunch menu at a restaurant serves an expected quantity of dishes, this may result in optimal functions 144 that have generated past prioritized task chain combinations 148 that may be retrieved, modified, or otherwise repurposed.

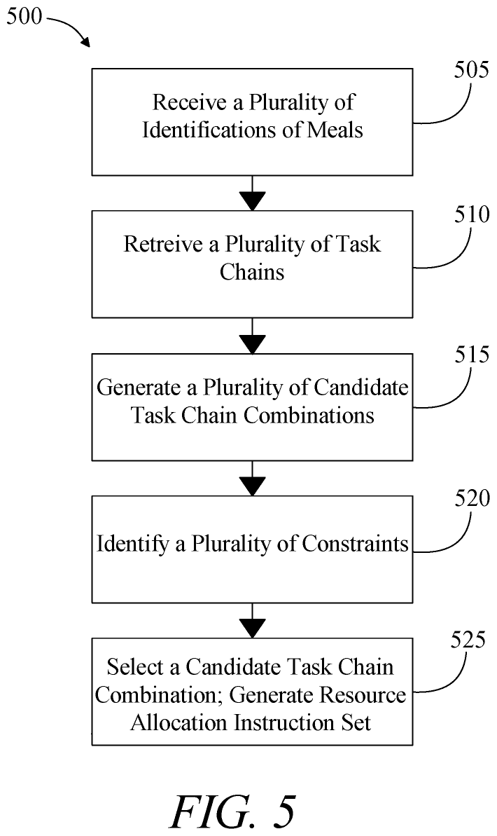

Referring now to FIG. 5, a method 500 for determining resource allocation instruction set for meal preparation using a machine-learning process is illustrated. At step 505, computing device 104 may be configured to receive a plurality of identifications of meals to be prepared, wherein a plurality of identifications of meals may include computing device 104 retrieving an ingredients list corresponding to meal from a database; this may be implemented, without limitation, as described above in reference to FIGS. 1-4.

At step 510, computing device 104 may retrieving a plurality of task chains, wherein retrieving may include retrieving, for each meal of the plurality of meals, a task chain identifying a plurality of sequentially ordered tasks for preparation of the meal; this may be implemented, without limitation, as described above in reference to FIGS. 1-4. Computing device may identify, for each task chain, a resource list identifying a plurality of resources, wherein each resource is associated with a task of the plurality of sequentially ordered tasks.

At step 515, computing device 104 may generate a plurality of candidate task chain combinations, wherein each task chain combination includes a first task chain of the plurality of task chains and a second task chain of the plurality of task chains, and a first task of the first task chain and a second task of the second task chain are concurrently performed using a resource associated with each of the first task and the second task; this may be implemented, without limitation, as described above in reference to FIGS. 1-4. Generating the plurality of candidate task chain combinations may include receiving feasibility training data, wherein feasibility training data further comprises a plurality of entries correlating task combinations with feasibility quantifiers, training a feasibility machine-learning model 132 using the feasibility training data, and generating a feasibility quantifier as a function of the feasibility machine-learning model 132, the first task, and the second task.

At step 520, computing device 104 may identify a plurality of constraints as a function of the plurality of identifications of meals, wherein the plurality of constraints includes at least a resource constraint and at least a timing constraint; this may be implemented, without limitation, as described herein in reference to FIGS. 1-6. Identifying a plurality of constraints to performing a plurality of candidate task chain combinations may include using a constraint machine-learning model 140 and a first plurality of candidate task chain combinations 124 to determine if a constraint exists, and measure the effect of the constraint on a candidate task chain.

At step 525, computing device 104 may select a candidate task chain combination, of the plurality of candidate task chain combinations, wherein selecting may include generating an objective function of the plurality of candidate task chain combinations, wherein the objective function is a mathematical function with a solution set including the plurality of candidate task chain combinations, the objective function generates an output scoring candidate task chain combinations according to at least a goal criterion, and selecting a candidate task chain combination for which the output of the objective function indicates a maximal satisfaction of the at least a goal criterion; this may be implemented, without limitation, as described herein in reference to FIGS. 1-6. Selecting the candidate task chain combination as a function of the optimizing may include generating a resource allocation instruction set 148 as a function of the optimized objective function 144. wherein selecting a candidate task chain combination further comprises using the objective function to rank candidate task chain combinations toward preparing a plurality of meals. Generating the objective function of the plurality of candidate task chain combinations may include performing linear optimization. Generating the objective function of the plurality of candidate task chain combinations may include performing mixed integer optimization. The objective function may include a loss function and generating the objective function with a solution set including the plurality of candidate task chain combinations may include minimizing the loss function. Generating the objective function may include determining a solution set including the plurality of candidate task chain combinations with regard to average preparation time. Generating an output of scoring candidate task chain combination according to at least a goal criterion may include scoring with regard to difference between an expected retrieval time and an expected time of completion. Selecting a candidate task chain combination may include generating a resource allocation instruction set, wherein a first task is prioritized as a function of the optimized objective function.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

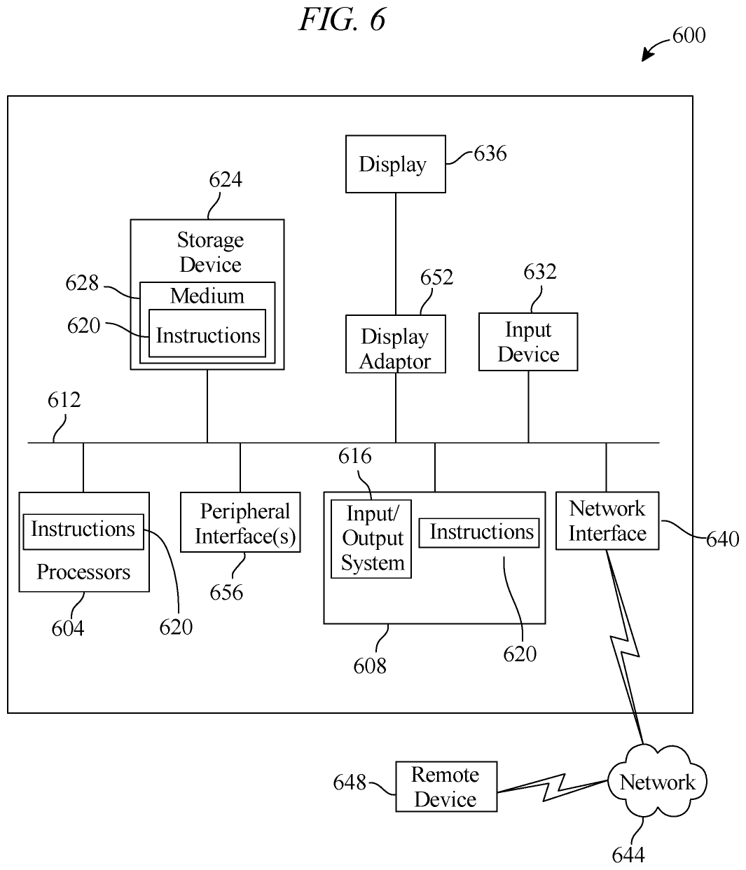

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC)

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for determining a resource allocation instruction set for meal preparation, the system comprising at least a computing device, wherein the at least a computing device is configured to:
receive a plurality of identifications of meals to be prepared;
retrieve a plurality of task chains, wherein retrieving further comprises:
retrieving from an online repository, for each meal of the plurality of meals, a task chain identifying a plurality of sequentially ordered tasks for preparation of the meal;
identifying, for each task chain, a resource list identifying a plurality of resources;
generate a plurality of candidate task chain combinations, as a function of a feasibility quantifier, wherein each task chain combination includes a first task chain of the plurality of task chains and a second task chain of the plurality of task chains, and wherein generating each candidate task chain combination of the plurality of task chain combinations further comprises:
receiving feasibility training data correlating a task combination and resources with a feasibility quantifier;
classifying the feasibility training data using a linear discriminant algorithm and a resource as input and determine wherein the resource is associated with each of the first task and the second task in the combination, and wherein, the first task chain and the second task chain in the task combination are sequentially listed and concurrently performed;
training a feasibility machine-learning model as a function of the feasibility training data; and
generating the feasibility quantifier as a function of the feasibility machine-learning model, a plurality of resource capabilities, the first task, and the second task;
identify a plurality of constraints as a function of the plurality of identifications of meals, wherein the plurality of constraints includes at least a resource constraint and at least a timing constraint, wherein identifying a plurality of constraints further comprises:
generating constraint training data from the plurality of constraints;
training a constraint machine-learning model using the constraint training data; and
identifying the plurality of constraints as a function of the plurality of candidate task chain combinations; and
select a candidate task chain combination, of the plurality of candidate task chain combinations, that satisfies the plurality of constraints, wherein selecting further comprises:
selecting, by the computing device, a candidate task chain combination, of the plurality of candidate task chain combinations, that satisfies the plurality of constraints, wherein selecting further comprises:
generating an objective function of the plurality of candidate task chain combinations; and
selecting a candidate task chain combination for which the output of the objective function indicates a maximal satisfaction of the at least a goal criterion.

2. (canceled)

3. The system of claim 1, wherein identifying the plurality of constraints to performing the plurality of candidate task chain combinations further comprises:
receiving constraint training data; and
measuring, using the trained constraint machine-learning model, the effect of the plurality of constraints on each candidate task chain combination of the plurality of task chain combinations.

4. The system of claim 1, wherein selecting the candidate task chain combination further comprises using the objective function to rank candidate task chain combinations toward preparing a plurality of meals.

5. The system of claim 1, wherein generating the objective function of the plurality of candidate task chain combinations further comprises performing linear optimization.

6. The system of claim 1, wherein generating the objective function of the plurality of candidate task chain combinations further comprises performing mixed integer optimization.

7. The system of claim 1, wherein:
the objective function includes a loss function; and
generating the objective function with a solution set including the plurality of candidate task chain combinations further comprises minimizing the loss function.

8. The system of claim 7, wherein generating the objective function further comprises determining a solution set including the plurality of candidate task chain combinations with regard to average preparation time.

9. The system of claim 1, wherein generating an output of scoring candidate task chain combination according to at least a goal criterion further comprises scoring with regard to difference between an expected retrieval time and an expected time of completion.

10. The system of claim 1, wherein selecting a candidate task chain combination further comprises generating a resource allocation instruction set, wherein a first task is prioritized as a function of the optimized objective function.

11. A method for determining a resource allocation instruction set for meal preparation, the method comprising:
receiving, by a computing device, a plurality of identifications of meals to be prepared;
retrieving, by the computing device, a plurality of task chains, wherein retrieving further comprises:
retrieving from an online repository, for each meal of the plurality of meals, a task chain identifying a plurality of sequentially ordered tasks for preparation of the meal;
identifying, for each task chain, a resource list identifying a plurality of resources;
generating, by the computing device, a plurality of candidate task chain combinations, as a function of a feasibility quantifier, wherein each task chain combination includes a first task chain of the plurality of task chains and a second task chain of the plurality of task chains, and wherein generating each candidate task chain combination of the plurality of task chain combinations further comprises:
receiving feasibility training data correlating a task combination and resources with a feasibility quantifier;
classifying the feasibility training data using a linear discriminant algorithm and a resource as input and determine wherein the resource is associated with each of the first task and the second task in the combination, and wherein, the first task chain and the second task chain in the task combination are sequentially listed and concurrently performed;
training a feasibility machine-learning model as a function of the feasibility training data; and
generating the feasibility quantifier as a function of the feasibility machine-learning model, a plurality of resource capabilities, the first task, and the second task;
identifying, by the computing device, a plurality of constraints as a function of the plurality of identifications of meals, wherein the plurality of constraints includes at least a resource constraint and at least a timing constraint, wherein identifying a plurality of constraints further comprises:
generating constraint training data from the plurality of constraints;
training a constraint machine-learning model using the constraint training data; and
identifying the plurality of constraints as a function of the plurality of candidate task chain combinations; and
selecting, by the computing device, a candidate task chain combination, of the plurality of candidate task chain combinations, that satisfies the plurality of constraints, wherein selecting further comprises:
generating an objective function of the plurality of candidate task chain combinations; and
selecting a candidate task chain combination for which the output of the objective function indicates a maximal satisfaction of the at least a goal criterion.

12. (canceled)

13. The method of claim 11, wherein identifying the plurality of constraints to performing the plurality of candidate task chain combinations further comprises:
receiving constraint training data; and
measuring, using the trained constraint machine-learning model, the effect of the plurality of constraints on each candidate task chain combination of the plurality of task chain combinations.

14. The method of claim 11, wherein selecting the candidate task chain combination further comprises using the objective function to rank candidate task chain combinations toward preparing a plurality of meals.

15. The method of claim 11, wherein generating the objective function of the plurality of candidate task chain combinations further comprises performing linear optimization.

16. The method of claim 11, wherein generating the objective function of the plurality of candidate task chain combinations further comprises performing mixed integer optimization.

17. The method of claim 11, wherein:
the objective function includes a loss function; and
generating the objective function with a solution set including the plurality of candidate task chain combinations further comprises minimizing the loss function.

18. The method of claim 17, wherein generating the objective function further comprises determining a solution set including the plurality of candidate task chain combinations with regard to average preparation time.

19. The method of claim 11, wherein generating an output of scoring candidate task chain combination according to at least a goal criterion further comprises scoring with regard to difference between an expected retrieval time and an expected time of completion.

20. The method of claim 11, wherein selecting a candidate task chain combination further comprises generating a resource allocation instruction set, wherein a first task is prioritized as a function of the optimized objective function.
